(19) United States
(12) Patent Application Publication
(10) Pub. No.: US 2013/0008188 A1
(43) Pub. Date: Jan. 10, 2013

(54) CRYOGEN HEAT PIPE HEAT EXCHANGER

(76) Inventors: Stephen A. McCORMICK, Warrington, PA (US); Michael D. Newman, Hillsborough, NJ (US)

(21) Appl. No.: 13/177,612

(22) Filed: Jul. 7, 2011

(51) Int. Cl. F17C 3/02; F17C 13/08

(52) U.S. Cl. 62/53.2; 62/45.1

(57) ABSTRACT

A cryogen heat exchanger includes a container having a sidewall defining a chamber in the container for containing a cryogen, and at least one heat exchange assembly having a first portion disposed in the chamber and extending through the sidewall to a second portion disposed in an atmosphere of a space external to the chamber and at an opposite side of the sidewall for providing heat transfer to the atmosphere.

### BACKGROUND

The present embodiments relate to heat transfer for refrigerating spaces such as for example spaces that are in transit.

In transit refrigeration (ITR) systems are known and may include cryogenic ITR systems which use known fin tube heat exchangers for liquid nitrogen and carbon dioxide chilled or frozen applications, or a snow bunker for solid CO₂ snow (or dry ice) chilled or frozen applications. Such known systems experience problems of safety, temperature control, cool down rates, dual temperature zone control, efficiency and fouling. For example, fins of a fin tube heat exchanger must be used in conjunction with a defrost cycle and related components in order to defrost frozen condensate from said fins. Such defrost cycle requires downtime of the heat exchanger and therefore additional cost to such system, which is undesirable.

Temperature control of solid CO₂ systems is necessary for increasing the overall efficiency of the process as well as making such system suitable for product delivery services, such as delivery of food products on a daily basis. With a temperature control system, chilled and frozen products can be transported effectively and more efficiently.

### BRIEF DESCRIPTION OF THE DRAWINGS

For a more complete understanding of the present embodiments, reference may be had to the following drawing figures taken in conjunction with the description of the embodiments, of which:

FIG. 1 shows a side cross-section view of a cryogen heat pipe heat exchanger embodiment mounted for use with a compartment for storage and transport of chilled or frozen products therein;

FIG. 2 shows a side, partial cross-section view of an example of where the cryogen heat pipe heat exchanger embodiment of FIG. 1 may be mounted to the compartment for in transit refrigeration (ITR);

FIG. 3 shows a side, cross-section view of another embodiment of a cryogen heat pipe heat exchanger;

FIGS. 4-5 show views of a plurality of the cryogenic heat pipe heat exchanger embodiment of FIG. 3 being used for a dual zone or dual compartment chilling and frozen refrigeration during ITR;

FIG. 6 shows a side, cross-section view of another embodiment of a cryogenic heat pipe heat exchanger of FIGS. 1 and 3;

FIG. 7 shows a side, cross-section view of still another embodiment of a cryogenic heat pipe heat exchanger;

FIG. 8 shows a top perspective isometric view of a portion of the cryogenic heat pipe heat exchanger in FIG. 7;

FIG. 9 shows a side view in cross-section of still another heat pipe heat exchanger embodiment mounted for use with a compartment for storage and transport of chilled or frozen products therein;

FIGS. 10A and 10B show side views in partial cross section of embodiments of the heat pipe heat exchanger of FIG. 9;

FIG. 11 shows a top isometric perspective view of the embodiment of FIG. 9;

FIG. 12 shows a top plan view in cross-section of the embodiment of FIG. 9;

FIG. 13 shows a top isometric perspective view of still another embodiment of a heat pipe heat exchanger;

FIG. 14 shows a top isometric perspective view of still another embodiment of a heat pipe heat exchanger; and

FIG. 15 shows a view of the heat pipe heat exchanger embodiments being used for in-transit refrigeration (ITR).

### DETAILED DESCRIPTION OF THE INVENTION

The reference to “cryogen” or “cryogenic substance” as used herein means a refrigerant which can be used in solid, liquid and/or gaseous phase to reduce a temperature of a product. In food freezing for example, liquid nitrogen and liquid carbon dioxide are used to extract heat from the product. The reduced temperatures usually are at below −80° F. (−62° C.).

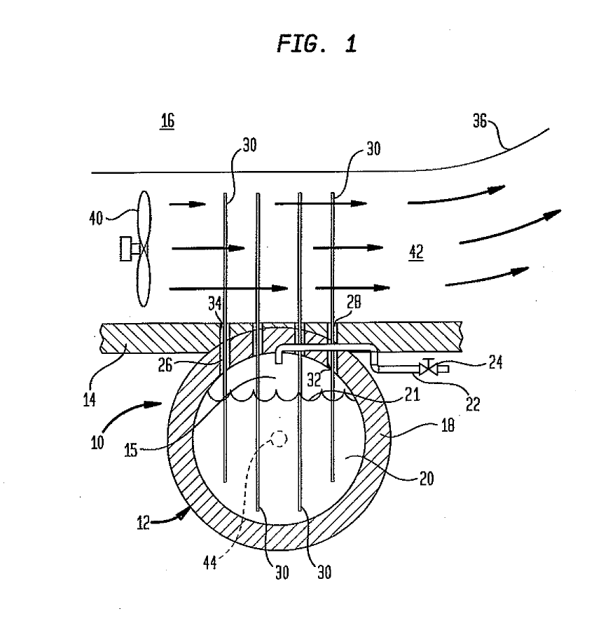

Referring to FIG. 1, a cryogen heat pipe heat exchanger of the present embodiments is shown generally at 10 and includes a tank 12 or pressure vessel mounted or adjacent to a wall 14 of a compartment having a space 16 for holding chilled or frozen products (not shown) such as for example food products. The tank 12, which may also be referred to as a cryogen tank, is constructed and arranged to receive therein either liquid nitrogen (N₂) or liquid carbon dioxide (CO₂) shown generally at 20. The liquid cryogen 20 will inevitably boil off as explained below and therefore vapor resulting from boil off of the liquid cryogen is exhausted from an atmosphere 15 above a surface 21 of the liquid cryogen 20 in the tank 12 through a pipe 22 which vents the cryogen vapor to atmosphere external to the tank. A valve 24 at the pipe 22 controls venting of the vapor. A side wall 18 of the tank 12, and the wall 14 of the compartment are both either insulated or vacuum jacketed.

The tank 12 can be mounted to the compartment wall 14 as shown in FIG. 1. The side wall 18 of the tank 12 is formed with a plurality of holes 26 extending therethrough. The wall 14 of the compartment is also formed with a corresponding number of holes 28 extending therethrough, such that when the tank 12 is mounted to the wall 14 the holes 26 of the tank are in registration with the holes 28 of the wall.

A plurality of heat pipes 30 extend from within the tank 12 through the holes 26 of the sidewall 18 and into the space 16 or chamber of the compartment. The plurality of heat pipes 30 may be provided in an array. Seals 32 or gasketing in the sidewall of the tank, and seals 34 or gasketing in the wall of the compartment prevent leakage or seepage of cryogen liquid and vapour from the tank 12 and the compartment 16. The heat pipes 30 can be fabricated from stainless steel or copper. By way of example only, any number of heat pipes 30 may be used depending upon the chilling or freezing application to be employed within the compartment 16, the products in the compartment, and the volume of the compartment. By way of example only, 25-100 heat pipes may be used. Each one of the heat pipes 30 extends approximately 6″-12″ into the compartment space 16. The positioning of the heat pipes 30 is such that an end portion of each one of the heat pipes is immersed in the liquid cryogen 20, while an opposite end portion of each one of the heat pipes is exposed to the atmosphere of the compartment space 16. Accordingly, the extreme cold of the liquid cryogen 20 is transferred by conduction through each heat pipe 30 to an opposite end of each one of the heat pipes exposed to the compartment space 16 atmosphere, such that heat is transferred from the warm gas of the compartment space 16 atmosphere into the cryogenic liquid 20 where it experiences a phase change and boils off. The gaseous or cryogen vapor is vented through the pipe 22 to the atmosphere external to the tank 12.

At a position where the heat pipes 30 protrude into the compartment 16 there is provided a shield 36 or shroud to protect the heat pipes, from any products within or shifting about the space of the compartment. The shroud 36 also facilitates air flow, represented generally by arrows 38 created by a circulation device 40, such as a fan for example, or a plurality of fans, across the heat pipes 30 for a higher heat transfer rate proximate the heat pipes. Accordingly, the temperature of the air flow downstream of the heat pipes 30 at a position generally represented at 42 is lower than a temperature of the air flow upstream of the heat pipes. The shroud 36 may be fabricated from metal. The fan 40 is the only moving part of the cryogen heat pipe heat exchanger embodiment. It is understood that a plurality of fans 40 may be used as well to increase next transfer effect.

By way of example, the tank may have dimensions of 1-3 meters in length with a volume of 300-1000 liters, although any size tank may be used.

The temperature of the space 16 in the compartment can be controlled by varying the rate of the air flow across the heat pipes 30. That is, if for example, the space 16 is to maintain a chilled temperature, such as for a food product for example, the fan(s) speed can be varied thereby effecting the heat transfer rate of the heat pipes and controlling internal temperature of the compartment.

The pressure of the cryogenic liquid 20 in the tank 12 can be adjusted to provide a differential temperature across the heat pipes 30. That is, temperature of the cryogenic liquid 20 varies directly with the pressure. If the pressure of the cryogenic liquid is higher, the temperature of the liquid would also be higher, and vice versa. Therefore, a lower temperature differential would be obtained across the heat pipes 30 with higher pressure liquid, while a higher differential would be obtained with lower pressure liquid.

Alternatively, the heat pipes 30 can be of the variable conductance type to adjust heat transfer rate for the compartment. That is, active control of heat flux can be effected by adding a variable volume liquid reservoir to the evaporator section of each heat pipe 30. Thus a wider range of heat fluxes and temperature gradients can be accommodated with different types of heat pipes being used.

In the embodiment of FIG. 1, the compartment 16 may be used for products that are stored waiting subsequent transfer and/or use. The tank 12 can be filled once or a plurality of times daily to maintain the products within the space at the desired chilled or frozen temperature. As the cryogen liquid 20 in the tank 12 boils off and is vented, cryogenic liquid can be filled through an inlet valve 44 positioned at a suitable location at the tank side wall 18.

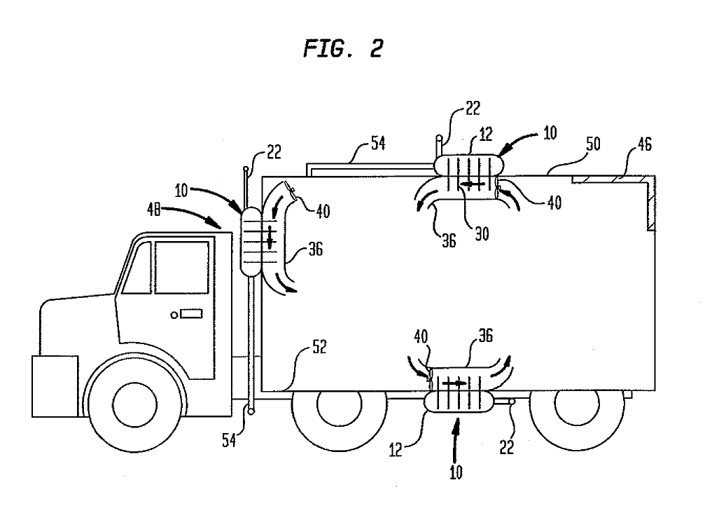

Referring to FIG. 2, the cryogen heat pipe heat exchanger 10 embodiment is mounted to a compartment 46 of a truck 48 or other in transit vehicle or mode of transportation to provide ITR. A single cryogen heat pipe heat exchanger 10 or a plurality thereof may be mounted to the truck 48. Although the heat pipe heat exchanger 10 may be mounted anywhere along a wall 50 of the compartment 46, top or side mounted embodiments are more desirable because the shroud 36 and heat pipes 30 protruding the compartment 46 will be exposed to and consume valuable floor space for pallets (not shown) or other products that would be deposited on a floor 52 of the compartment. Mounting the cryogen heat pipe heat exchanger 10 to the top or side wall of the compartment, as opposed to the bottom 52 of the compartment, will also protect the shroud and heat pipes extending into the compartment from being damaged due to products or shifting pallets within the compartment.

As shown in FIG. 2, for those embodiments 10 mounted to the top or side wall of the compartment of the truck 48, pipe(s) 54 would be used to connect the tanks 12 to a source (not shown) of liquid cryogen so that personnel would not have to climb on top of the truck with cryogen hoses to fill the tanks.

The heat pipes 30 of the cryogen heat pipe heat exchanger 10 do not require that the cryogen liquid 20 and gases enter the compartment 16. The heat pipes 30 transfer heat so efficiently that fins of known systems are not required and therefore fouling issues of the fins are completely avoided.

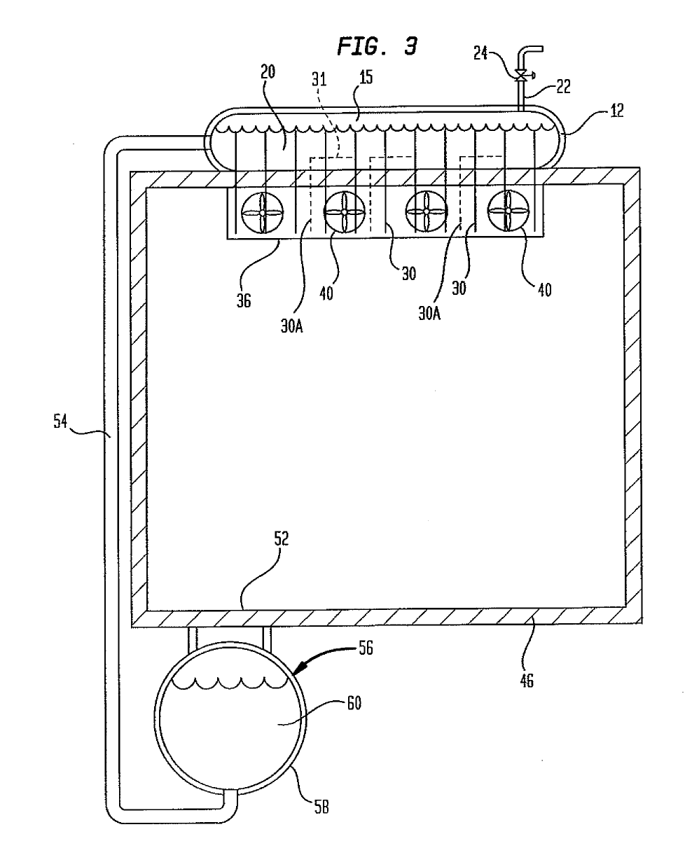

FIGS. 3-6 show other embodiments of the cryogen heat pipe heat exchanger.

Referring to FIG. 3, the cryogen heat pipe heat exchanger 10 of the present embodiments is shown mounted to the top of the compartment 16 and which is constructed and arranged to be provided with liquid cryogen through a pipe 54 connecting the tank 12 to a liquid cryogen storage vessel 56. The vessel 56 is the source for the liquid cryogen during for example ITR. The vessel 56 may be mounted for operation beneath the bottom 52 of the compartment 16. The vessel 56 has a side wall 58 which is vacuum jacketed or surrounded by insulation material, and the pipe 54 distributing the liquid cryogen 60 to the tank is also insulated or vacuum jacketed. The vessel 56 is maintained under a pressure at a range of 2 to 6 barg to force the liquid cryogen 60 from the vessel 56 through the pipe 54 and into the tank 12, wherein the tank operates in a manner similar to that described with respect to FIGS. 1-2 above.

Heat pipes 30A may be used in addition to or alternatively from the heat pipes 30. The heat pipes 30A have a portion 31 which is bent or turned and disposed in the tank 12, such that the portion 31 extends substantially parallel to the tank's longitudinal or transverse axis and along or proximate to a lower area or bottom of the tank. The portion 31 increases the residence time of the heat pipe 30A in the cryogenic liquid 20 so that heat transfer effect can continue in a uniform rate, as the portion 31 does not become exposed to the less efficient heat transfer vapor until the liquid has substantially boiled off. The heat pipes 30A can be used with all the embodiments herein.

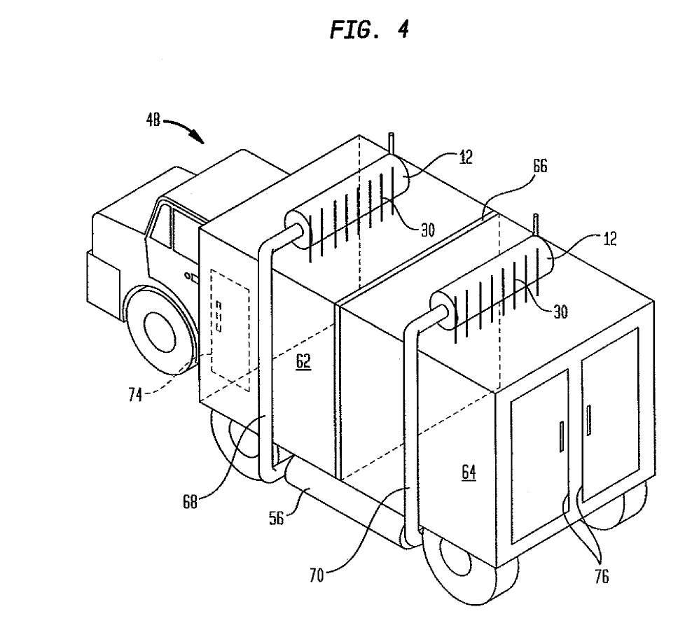

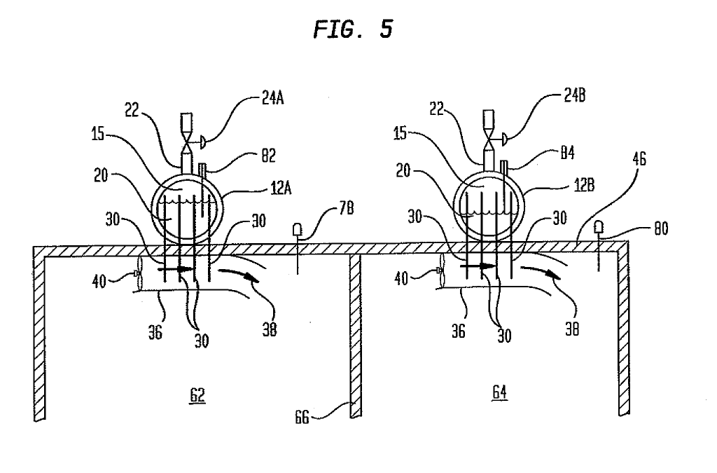

As shown in FIGS. 4-5, the compartment 16 can be segregated into a plurality of spaces 62,64 by for example an insulated partition wall 66. Each of said spaces 62,64 can have a different temperature depending upon the products therein and the temperature necessary for same to be preserved. Therefore, for example, the space 62 can be for frozen product, while space 64 will be for chilled product. The vessel 56 disposed at the bottom of the compartment is similar to that of FIG. 3 and would have insulated piping 68,70 extending therefrom to a corresponding one of the cryogen heat pipe exchanger embodiments 12 disposed at for example a top of the compartment over a corresponding one of the spaces 62,64 to have a chilled or frozen atmosphere therein. In this manner of construction, the vessel 56 provides only the necessary amount of cryogen liquid to both of the tanks 12, thereby providing efficient use of the cryogen liquid. Doors 74,76 provide access to corresponding ones of the spaces 62,64.

Referring to FIG. 5, the level of the cryogen liquid 20 in one of the tanks 12 can be maintained at a higher level in order to provide for a frozen atmosphere in the space 62; while the other tank 12 can be provided with a lower cryogenic liquid level if the space 64 is only to be for a chilled atmosphere.

Even though the tanks 12 draw the liquid cryogen from a common vessel 56, the valves 24 for each of the tanks are adjusted to control the amount of liquid cryogen 20 in a respective one of the tanks. Therefore, if the liquid cryogen 20 in the tank 12A is suppose to be for a freezing atmosphere in the space 22, then the control valve 24A will be opened in order to adjust the level of the cryogen liquid in the tank to the necessary higher level for such frozen atmosphere. Similarly, the control valve 24B will be opened to the level necessary in order to maintain the liquid cryogen level at a necessary lower level in the tank 12B in order to provide a chilled atmosphere for the space 64. The control valves 24A,24B are opened wider in order to increase the level of liquid cryogen 20 in the tanks 12A,12B.

Sensors 78,80 are mounted for sensing the temperature in each one of the corresponding spaces 62,64 and can be connected to a control panel (not shown) for receiving the temperature sensed in the spaces 62,64 and then adjusting the control valves 24A,24B in order to determine the amount of liquid cryogen necessary for each one of the tanks 12A,12B, depending upon the temperature that must be obtained and maintained in the corresponding spaces 62,64. Sensor probes 82,84 (such as capacitance probes) are also mounted to each one of the corresponding tanks to sense the level of the cryogen liquid 20 in the corresponding tank and generate a signal of same which is transmitted to the control panel as well. Accordingly, an immersion height of the heat pipes 30 in the liquid cryogen can be maintained at a continuous level so that the temperature of the space 62,64 so affected is also maintained at the desired temperature. Temperatures in these zones can also be maintained by adjusting tank pressures or with the use of variable conductance heat pipes as discussed above.

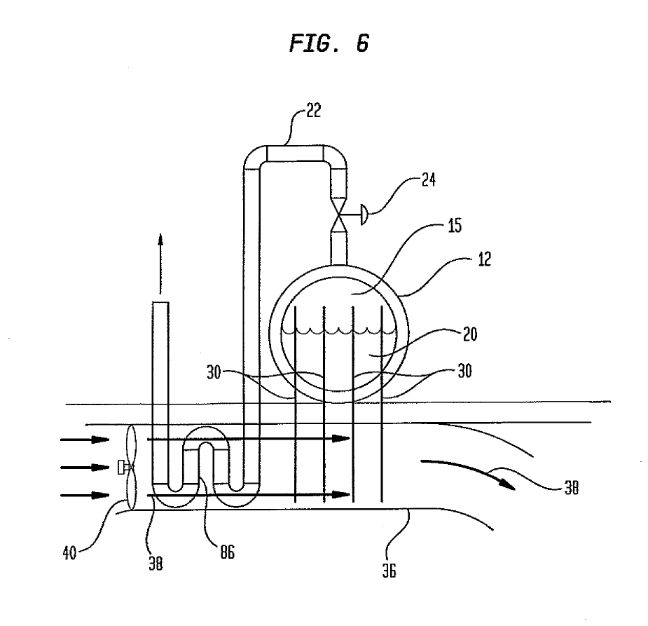

In FIG. 6, the cryogen heat pipe heat exchanger 10 is provided with a secondary heat exchange coil 86 or circuit which is formed from the vent pipe 22 and disposed in the air flow 38 of the compartment spaces 16,62,64 upstream of the heat pipes 30. Such construction provides for precooling of the air flow 38 prior to same contacting the heat pipes 30. Thereafter, the cryogenic vapor is exhausted to the atmosphere external to the compartment. The secondary heat exchange coil 86 can be used with the embodiments discussed above in FIGS. 1-5.

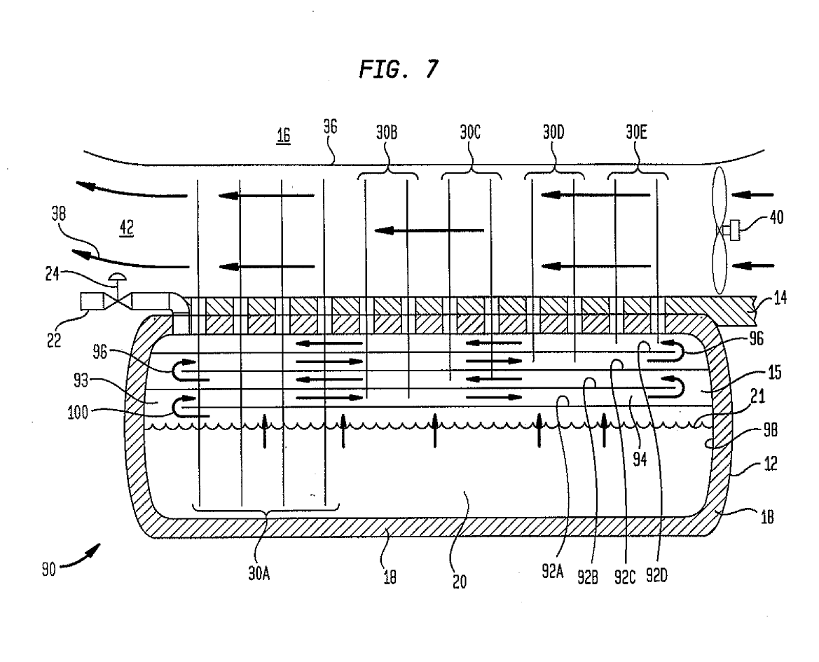

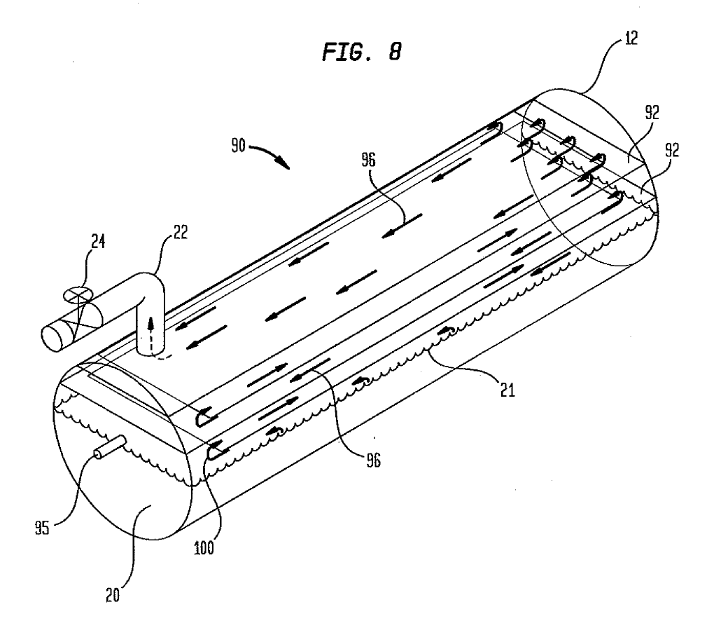

FIGS. 7-8 show still another embodiment of a cryogen heat pipe heat exchanger 90. In this embodiment, the tank 12 includes a labyrinth pathway or a configuration of plates consisting of at least one and as shown a plurality of plates 92 extending in the atmosphere 15 of the tank above the cryogenic liquid 20. The plates 92 may be manufactured from stainless steel. The construction and arrangement of the plates 92 provides a continuous alternating or sinuous passageway 94 such that boiled off gas or the cryogen vapor from the cryogen liquid 20 is directed between the plates and guided upward to the vent 22, as indicated generally by the flow of the arrows 96 proceeding along the passageway. The cryogenic liquid may be supplied to the tank 12 through an inlet 95 or port.

Should one or more of the heat pipes 30 break or the seals 32,34 or gaskets become ineffective, the plurality of plates 92 will substantially reduce if not eliminate any cryogen liquid or vapor being released into the compartment 16, which is an important safety aspect of this and the other embodiments. The embodiment of FIGS. 7-8 achieves similar efficiencies as that of the embodiment of FIG. 6.

None of the plates 92 contact the cryogen liquid, but instead are disposed in the atmosphere 15 above the upper surface 21 of the cryogen liquid 20.

As shown in particular in FIG. 7, the heat pipes 30 have different lengths 30A,30B,30C,30D and 30E (collectively referred to as 30A-30E). The different lengths of the heat pipes 30A-30E determine whether same are exposed to the cryogenic liquid and cryogenic vapor, or just exposed to the cryogenic vapor, as shown in FIG. 7. That is, the heat pipes 30A extend from the cryogenic liquid 20 through the passageway 94 transverse to a longitudinal axis of the plates 92 and into the compartment 16 where they are exposed to the air flow 38 provided by the fan(s) 40 for providing the heat transfer effect for said compartment.

The heat pipes 30B-30E are each only exposed to the cryogenic vapor in the atmosphere 15 of the tank 12, after which all extend into the compartment 16, wherein they are exposed to the air flow 38 by the fan(s) 40 for providing the heat transfer effect for said compartment. As can be seen in FIG. 7, the heat pipes 30B-30E extend, respectively, to a decreasing depth in the atmosphere 15 as they get closer to the fan(s) 40. That is, the heat pipes 30B extend into the atmosphere 15 down to a depth just above a lower most plate 92A, while the heat pipes 30C extend to a lesser depth, the heat pipes 30D extend to still a lesser depth in the atmosphere 15, while the heat pipes 30E extend only into the atmosphere 15 above an uppermost plate 92D. Therefore, as can be seen by the arrangement of the heat pipes 30A-30E, the greatest heat transfer rate will be provided by the heat pipes 30A, while the lowest heat transfer rate will be provided by the heat pipes 30E. In effect, the shorter heat pipes (30E for example) contact the warmer gas in the atmosphere 15 while the longer heat pipes (30A for example) contact the coldest gas in the atmosphere 15 and the cryogen liquid 20. The plurality of plates 92 creating the sinuous passageway 94 provides for increased residence time of the cryogen vapor in the passageway 94 to provide for the necessary chilling of the heat pipes 30A-30E disposed therein.

The plates 92A-92D are arranged to provide for the passageway 94. Referring also to FIG. 8, a lowermost one of the plates 92A is connected at three of its sides to an inner surface 98 of the tank 12, while one side of said plate 92A extends toward but does not contact the opposed portion of the inner surface 98 of the tank 12. The space between the plate 92A and the inner surface 98 of the tank 12 provides an opening 93 or inlet to the passageway 94. The next plate 92B positioned directly above the lowermost plate 92A has three of its sides attached to the inner surface 98 such that one of said sides is attached at a position above where the lower plate 92A is spaced from the inner surface 98, thereby providing the inlet 93 through which the cryogen vapor flows to the passageway 94 as indicated by arrow 100. The next successive upward plate 92C is affixed to the inner surface similar to the plate 92A, thereby providing the necessary space for the gas flow to continue. The plate 92D is the uppermost plate in the atmosphere 15 and is mounted to the inner surface 98 similar to the plate 92B, thereby directing the gas flow into the vent pipe 22.

Each one of the plates 92 has three sides connected to, such as by welding, the inner surface 98 of the tank 12, while the opposed end of each one of the plates 92 extends into the atmosphere 15 of the tank 12, but does not contact the inner surface 98 at an opposed side of the tank 12. The heat pipes 30 extend or penetrate through the plates, but it is not necessary for the heat pipes to be connected to the plates. In an attempt to minimize any bypass of cryogenic gas through the plates 92, the holes in the plates through which the heat pipes 30 extend are provided with tolerances as tight as possible to avoid seepage of the cryogenic gas through the plates 92 along the heat pipes 30.

All of the embodiments discussed above with respect to FIGS. 2-7 also provide for gasketing or seals 32,34 such as those called for in FIG. 1, where the heat pipes 30 extend through the wall 18 of the tank 12 and the wall 14 of the compartment 16.

The compartment 16 of FIGS. 1-8 may be mounted or constructed as a part of a truck, automobile, railcar flatbed, barge, shipping container or other floating vessel, etc., hence the ability to provide in-transit refrigeration (ITR).

The reference to “solid CO₂ snow” and “dry ice” as used herein are used interchangeably for purposes of describing the present embodiments.

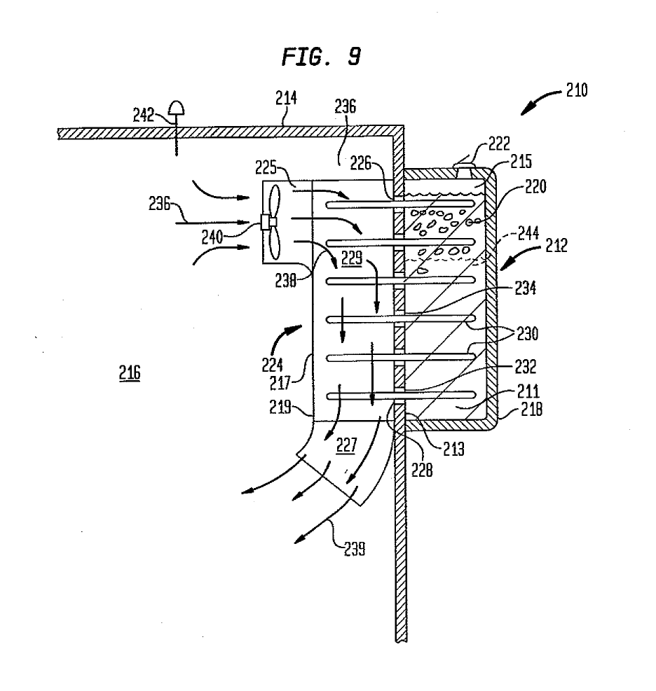

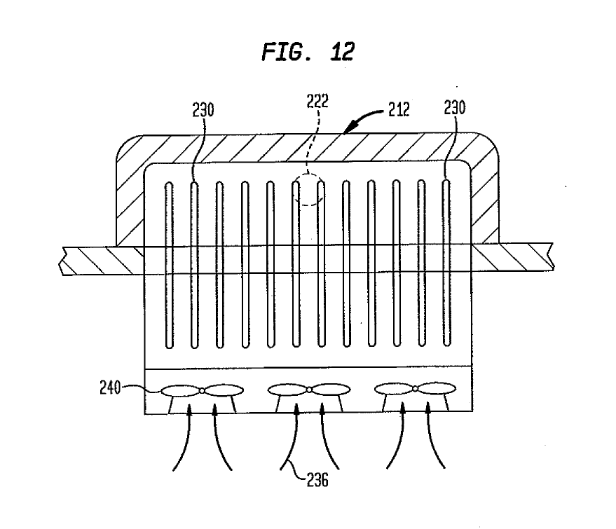

Referring to FIGS. 9-12, another heat pipe heat exchanger of the present embodiments is shown generally at 210 and includes a container 212 or housing mounted to a wall 214 or roof of a compartment having a space 216 for holding chilled or frozen products (not shown), such as for example food products. A side wall 218 of the container 212 and the wall 214 of the compartment are both either insulated or vacuum jacketed, except for a portion 213 of the wall which may or may not be insulated or vacuum jacketed. The container 212, which may also be referred to as a dry ice container, is constructed and arranged with a space 211 therein to receive therein solid carbon dioxide (CO₂) or dry ice shown generally at 220. The dry ice 220 may be in snow or pellet form. The dry ice 220 will inevitably sublime as further explained below and therefore, vapor resulting from sublimation of the dry ice is exhausted from an atmosphere 215 above a surface of the dry ice 220 through a vent 222 in communication with the atmosphere external to the container.

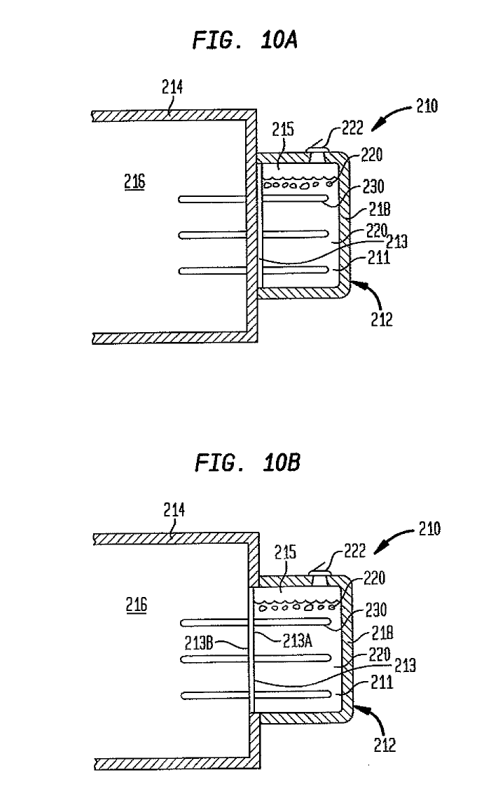

The cryogen heat pipe heat exchanger 210 may be mounted to the compartment wall 214 in different ways. FIG. 10A is representative of a retrofit of the cryogen heat pipe heat exchanger to the compartment side wall 214. The embodiment of FIG. 10B is an example of the cryogen heat pipe heat exchanger 210 being constructed integral with the compartment side wall 214 from the original construction of the compartment side wall 214. Referring again to the embodiment of FIG. 10A, the side wall 218 of the container 212 is insulated on five sides, while the sixth side wall 213 is a single sheet of highly conductive metal, such as for example stainless steel or aluminum. Since the side wall 214 of the compartment is already insulated, there is no necessity for the container 212 to have the side wall 213 be insulated as well. That is because the side wall 214 will function with the necessary insulatory effect for the space 216. This construction also simplifies the retrofit installation and safety. The space 211 is completely sealed and the heat pipes 230 are sealed where they extend through the side wall 213 so that only subliming gas will escape the space 220 through the vent 222, and not into the space 216.

The embodiment of FIG. 10B is essentially the same as the embodiment of FIG. 10A, except that the sidewall 213, the uninsulated side wall formed of a sheet of stainless steel or aluminum for example, is the sole partition separating the container space 211 from the compartment space 216. The sidewall 213 is common to or shared by the compartment and the container 212. That is, as shown in FIG. 10B, the sidewall 213 has a surface area 213A exposed to the container space 211, and a surface area 213B at an opposite side of the sidewall 213 and exposed to the compartment space 216. Since the embodiment in FIG. 10B would constitute the initial or original construction of the cryogen heat pipe heat exchanger 210, there is no reason to have the side wall 214 completely insulated along the interface between the spaces 211,216. This is because the thin sheet sidewall 213 will be sufficient in order to retain the cryogen snow or pellets 220 in the space 211 to prevent same and any vapor or gas in the atmosphere 215 from escaping into the compartment space 216. The insulated wall 213 also provides additional surface area for heat exchange with the space 16 and the CO₂ snow 220 or pellets stored in the space 211.

The container 212 is mounted to the compartment wall 214 as shown in FIG. 9 (or FIGS. 10A, 10B). The wall 214 is formed with a plurality of holes 226 extending therethrough. An airflow shroud 224 or duct is mounted in the compartment to an opposed side of the wall 214 from that of the container 212. The shroud 224 includes a housing 217 having a side wall 219 mounted in the compartment to an opposed side of the wall 214 from that of the container 212. The shroud 224 may be fabricated from metal. The housing sidewall 219 is not insulated. The side wall 219 has a plurality of holes 228 therethrough, which holes are in registration with the holes 226 in the wall 214 for a purpose to be described further below. When the container 212 is mounted to an exterior of the wall 214 the holes 226 are in registration with the holes 228 of the housing side wall 219.

The shroud housing 217 includes an inlet 225, an outlet 227 or discharge, and a channel 229 therebetween. The outlet 227 may be curved as an arcuate portion (as shown) of the housing 217 to direct the chilled or frozen air back into the space 216. The airflow 238 is directed from the space 216 of the compartment by the fans 240 to the inlet 225 of the shroud 224, through the channel 229 to the outlet 227 for the chilled or frozen air to be returned to the space 216.

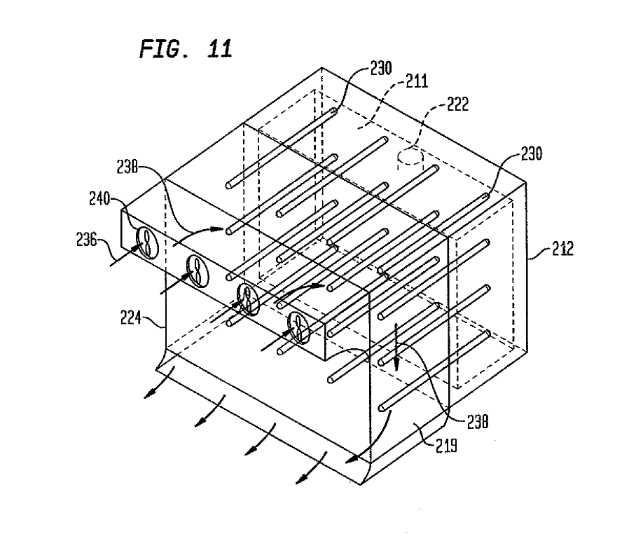

A plurality of heat pipes 230 extend from within the container 212 through the holes 226 of the wall 214 and the holes 228 of the sidewall 219 into the space 216 of the compartment. The plurality of heat pipes 230 may be arranged in an array such as shown in FIG. 11 for example. Seals 232 or gasketing in the wall 214, and seals 234 or gasketing in the sidewall 219 prevent leakage or seepage of dry ice vapour from the container 212 into the compartment 216.

The heat pipes 230 can be fabricated from stainless steel or copper. By way of example only, any number of heat pipes 230 may be used depending upon the chilling or freezing application to be employed within the compartment 216, the products in the compartment, and the volume of the compartment. By way of example only, 25-100 heat pipes may be used. Each one of the heat pipes 230 extends approximately 6″-12″ into the compartment space 216. The positioning of the heat pipes 230 is such that an end portion of each one of the heat pipes is immersed in the dry ice 220, while an opposite end portion of each one of the heat pipes is exposed to the atmosphere of the compartment space 216 being drawn into the shroud 224. Accordingly, due to the extreme cold of the dry ice 220, heat is transferred from the warm gas of the compartment space 16 atmosphere into the dry ice solid 220 where it experiences a phase change and sublimes. The gaseous or dry ice vapor is vented through the vent 222 to the atmosphere external to the container 212.

At a position where the heat pipes 230 protrude into the shroud 224, the shroud facilitates airflow, represented generally by arrows 238 created by a fan 240, or a plurality of fans, across the heat pipes 230 for a higher heat transfer rate proximate the heat pipes. Accordingly, a temperature of the airflow 236 proximate the fan 240 is greater than a temperature of the airflow downstream of the heat pipes 230 at a position generally represented at 239. The fan 240 is the only moving part of the dry ice heat pipe heat exchanger embodiment. It is understood that a plurality of fans 240, see for example FIG. 11, may be used as well to increase heat transfer effect.

The shroud 224, also shown in FIG. 11 for example, protects the heat pipes 230 from being damaged by products which may shift in the compartment or personnel moving about the compartment.

By way of example only, the container 212 of FIG. 9 may have dimensions of 1.5 meters in length with a volume of 115 liters, although any size container may be used.

The temperature of the space 216 in the compartment can be controlled by varying the rate of the airflow 238 across the heat pipes 230. That is if, for example, the space 216 is to maintain a chilled temperature, such as for a food product for example, the fan(s) speed can be varied thereby effecting the heat transfer rate of the heat pipes 230 and controlling internal temperature of the compartment. If, on the other hand for example, the products must be maintained in a frozen temperature, then the speed of the fans 240 will be accelerated to thereby increase the heat transfer effect of the air in the compartment passing over the heat pipes and further reduce the temperature of the air in the compartment.

A temperature sensor 242 is also provided for the compartment. The temperature sensor 242 will transmit a temperature of the air in the compartment to a remote location or a controller (not shown) in order to determine whether the speed of the fan 240 should be increased or decreased to adjust the heat transfer effect across the heat pipes 230. As the dry ice 220 sublimes, a level of the dry ice in the container becomes reduced, as indicated generally at 244.

The embodiment of FIGS. 9-12 is well suited for use with a vertical wall of a compartment, such as shown for example at FIG. 9. Such embodiment can however be used with a top wall or roof of the compartment.

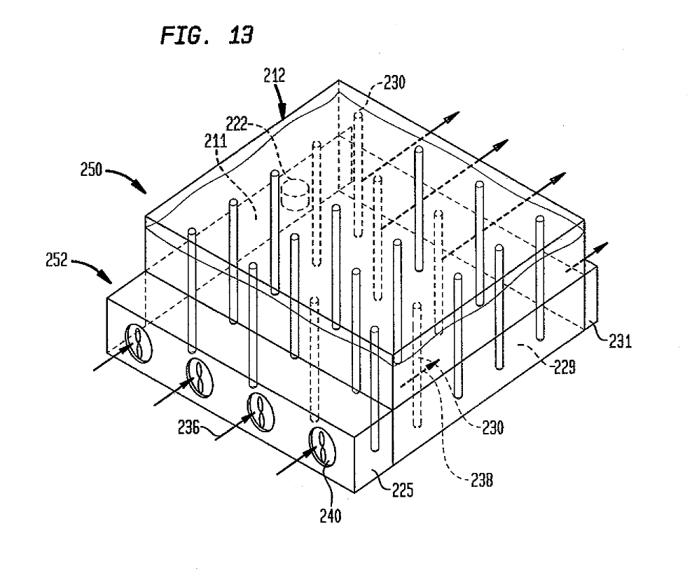

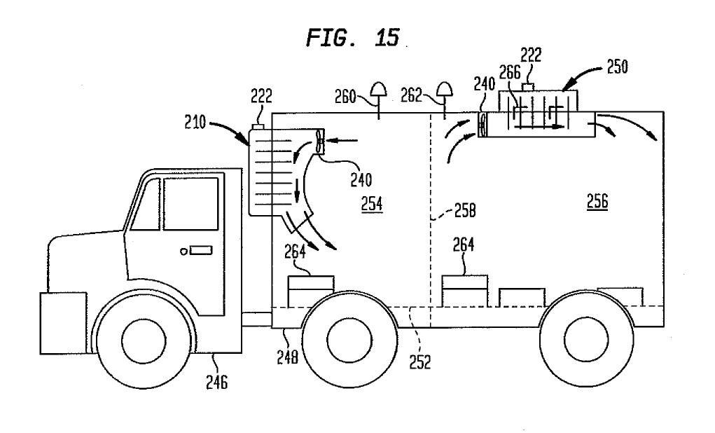

Referring to FIG. 13, another embodiment of the dry ice a pipe heat exchanger is shown generally at 250. The construction and arrangement of the components of the embodiment 250 are similar to those of the embodiment 210 shown with respect to FIGS. 9-12, unless otherwise indicated. As shown in FIG. 13 and FIG. 15, the construction of the embodiment 250 may be mounted to a horizontal wall or a roof of an ITR vehicle or other mode of ITR transportation. The airflow shroud 252 of the embodiment 250, which is disposed in the compartment for heat transfer, is provided with a substantially rectangular shape, although it is understood that an outlet 231 or discharge end of the shroud 252 where the cooled or chilled airflow is released into the compartment, can also be bent or provided with an arcuate shape, similar to that shown with respect to the shroud 224 of FIG. 9.

By way of example only, the container 212 of FIG. 13 may have dimensions of 1.5 meters in length with a volume of 115 liters, although any size container may be used.

The embodiment discussed above with respect to FIG. 13 also provides for gasketing or seals 232,234 such as those called for in FIG. 9, where the heat pipes 230 extend through the wall 214 of the container 212, and the wall 218 of the compartment 216.

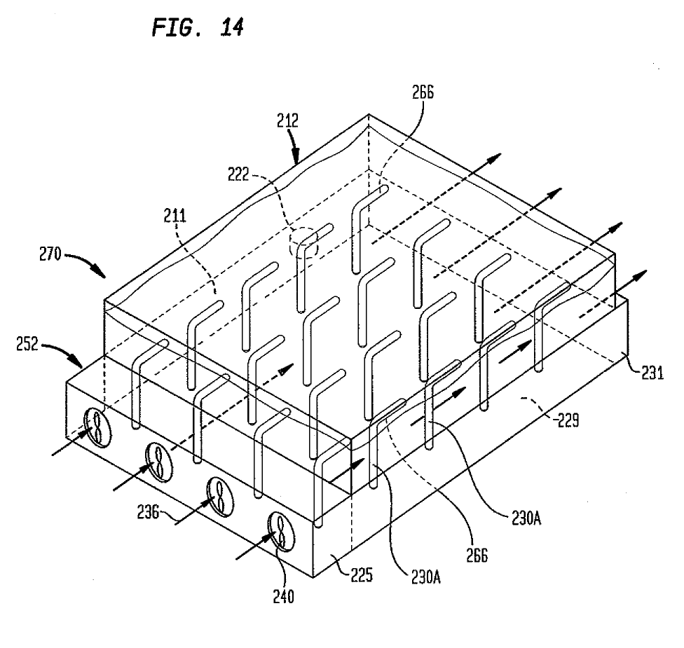

Referring also to FIG. 14, another embodiment of the dry ice heat pipe heat exchanger is shown generally at 270. The construction and arrangement of the components of the embodiment 270 are similar to those of the embodiment 250 shown with respect to FIG. 13, unless otherwise indicated. As shown in FIG. 14, and FIG. 15 discussed below, the construction of the embodiment 270 may be mounted to a horizontal wall or a roof of an ITR vehicle or other mode of ITR transportation. The airflow shroud 252 of the embodiment 250 is provided with a substantially rectangular shape, although an outlet 231 or discharge end of the shroud 252 where the cooled or chilled airflow is released into the compartment, can also be bent or provided with an arcuate shape, similar to that shown with respect to the outlet 227 of the shroud 224 in FIG. 9. Heat pipes 230A of the embodiment 270 have a portion 266 which is bent and extends substantially parallel to a lower portion or bottom of the container space 211. That is, where each one of the heat pipes 230A extends from the shroud channel 229 up into the container space 211, the heat pipe 230A is turned or bent such that the portion 266 of the heat pipe 230A disposed in the container space 211 remains proximate to a lower portion or bottom of the space. This manner of construction provides for a greater continuous period of time for uniform heat transfer because the bent portion 266 remains covered by the dry ice 220 until such time as the dry ice has sublimed and evaporated to bring the level of the dry ice down to the bent portion 66 of the heat pipe. This provides for a continuous, uniform heat transfer capability until such time as the dry ice reaches a particular level in the container space 211.

Referring to FIG. 15, the dry ice heat pipe heat exchanger 210 embodiment is mounted to a compartment attached to a truck 246 or other in transit vehicle to provide ITR. A single dry ice heat pipe heat exchanger 210 or a plurality thereof may be mounted to the truck 248. Although the heat pipe heat exchanger 10 may be mounted anywhere along the wall 214 of the compartment, top or side mounted embodiments may be more effective because the shroud 224 and heat pipes 230 protruding into the compartment will not be exposed to and consume valuable floor space for pallets 264 or other products that would be deposited on a floor 252 of the compartment. Mounting the dry ice heat pipe heat exchanger 210 to the top or side wall of the compartment, as opposed to a bottom 248 of the compartment, will also protect the shroud 224 and heat pipes 230 extending into the compartment from being damaged due to products or pallets 264 shifting within the compartment.

FIG. 15 also shows the other embodiment of a dry ice heat pipe heat exchanger 250 being mounted to a roof of a compartment in which heat exchange is to occur.

As shown in FIG. 15, the space 216 can be segregated into a plurality of spaces 254,256 or regions by for example an insulated partition wall 258. Each of said spaces 254,256 can have a different temperature depending upon the products therein and the temperature necessary for same to be preserved. Therefore, for example, the space 254 can be for frozen product, while the space 256 can be for chilled product.

The heat pipes 230 of the dry ice heat pipe heat exchangers 210,250 do not permit the dry ice 220 and related gases to enter the spaces 216,254,256. The heat pipes 230 transfer heat so efficiently that fins of known systems are not required and therefore fouling issues of the fins are completely avoided.

Sensors 260,262 are mounted for sensing the temperature in each one of the corresponding spaces 254,256 and can be connected to a control panel (not shown) for receiving the temperature sensed in the spaces and then adjusting the fan 240 speed in order to provide the necessary heat transfer effect across the heat pipes, depending upon the temperature that must be obtained and maintained in the corresponding spaces 254,256 for the products 264, such as for example food products.

The dry ice 220 for either of the embodiments 210,250 can be loaded into the container through a door, or from snow horns (not shown) connected to a CO₂ bulk storage tank (not shown).

In the embodiments of FIGS. 9-15, the spaces 21, 254,256 of the compartment may be used for products that are stored waiting subsequent transfer and/or use. The container 212 can be filled once or a plurality of times daily to maintain the products within the space at the desired chilled or frozen temperature. As the dry ice 220 in the container 212 sublimes and vapor is vented, fresh dry ice can be provided to the container to recharge same in the container.

It will be understood that the embodiments described herein are merely exemplary, and that one skilled in the art may make variations and modifications without departing from the spirit and scope of the invention. All such variations and modifications are intended to be included within the scope of the invention as described and claimed herein. Further, all embodiments disclosed are not necessarily in the alternative, as various embodiments of the invention may be combined to provide the desired result.

What is claimed is:

1. A cryogen heat exchanger, comprising a container having a sidewall defining a chamber in the container for containing a cryogen, and at least one heat exchange assembly having a first portion disposed in the chamber and extending through the sidewall to a second portion disposed in an atmosphere of a space external to the chamber and at an opposite side of the sidewall for providing heat transfer to the atmosphere.

2. The cryogen heat exchanger of claim 1, wherein the at least one heat exchange assembly comprises at least one or a plurality of heat pipes.

3. The cryogen heat exchanger of claim 2, wherein the at least one or the plurality of heat pipes are in contact with the cryogen.

4. The cryogen heat exchanger of claim 1, further comprising a shroud disposed in the atmosphere and having a channel therein which receives the at least one heat exchange assembly and facilitates air flow through the channel.

5. The cryogen heat exchanger of claim 4, further comprising at least one fan mounted for operation in the atmosphere for circulating the air flow through the channel over the at least one or the plurality of heat pipes.

6. The cryogen heat exchanger of claim 2, wherein the first portion of the at least one or the plurality of heat pipes is bent for said first portion to extend proximate to a bottom of said chamber.

7. The cryogen heat exchanger of claim 1, wherein the container is mounted to an in transit mode of transportation selected from a truck, automobile, barge, shipping container and railcar.

8. The cryogen heat exchanger of claim 2, wherein the cryogen comprises liquid nitrogen.

9. The cryogen heat exchanger of claim 8, wherein the sidewall further comprises a vent in communication with the chamber to remove cryogen vapor from the chamber, and a pipe portion connected to the vent and extending as a heat exchange circuit disposed in the atmosphere for providing heat transfer to the atmosphere.

10. The cryogen heat exchanger of claim 8, further comprising a first sensor exposed to the chamber for sensing an amount of the liquid nitrogen in the chamber, and a second sensor exposed to the atmosphere for sensing a temperature of the atmosphere.

11. The cryogen heat exchanger of claim 8, further comprising a liquid cryogen vessel mounted for use with the container, and a pipe connecting the liquid cryogen vessel to the chamber of the container for delivering the liquid nitrogen to the chamber.

12. The cryogen heat exchanger of claim 8, wherein the container further comprises a plurality of plates mounted in the chamber above a surface of the liquid nitrogen for providing a continuous passageway for vapor from the liquid nitrogen to contact the first portion of the at least one heat exchange assembly.

13. The cryogen heat exchanger of claim 12, wherein the at least one heat exchange assembly comprises a plurality of heat pipes, and wherein the first portion of at least one of the plurality of heat pipes extends from at least one of the plurality of plates in the chamber.

14. The cryogen heat exchanger of claim 12, wherein the at least one heat exchange assembly comprises a plurality of heat pipes, and wherein at least one of the plurality of heat pipes has the first portion contacting the vapor, the at least one of the plurality of plates and the liquid nitrogen in the chamber; and at least another one of the plurality of heat pipes has the first portion contacting the vapor in the chamber.

15. The cryogen heat exchanger of claim 2, wherein the cryogen comprises a cryogen substance selected from the group consisting of dry ice and CO₂ snow pellets.

16. The cryogen heat exchanger of claim 15, further comprising a shroud disposed in the atmosphere, the shroud comprising an inlet for airflow of the atmosphere to be introduced into the shroud, a channel in communication with the inlet and in which the second portion of the at least one heat exchange assembly is disposed for contacting the airflow, an outlet in communication with the channel for discharging the airflow back to the atmosphere, and at least one fan mounted for operation at the shroud for circulating the airflow in the atmosphere to the inlet and through the channel.

17. The cryogen heat exchanger of claim 15, further comprising a sensor mounted for sensing a temperature of the atmosphere.

18. The cryogen heat exchanger of claim 15, wherein the sidewall comprises a section having a first surface area exposed to the chamber and a second surface area opposite to the first surface area and exposed to the atmosphere of the space, the section separating the chamber from the atmosphere of the space.
